(19) United States
(12) Patent Application Publication
(10) Pub. No.: US 2006/0153453 A1
(43) Pub. Date: Jul. 13, 2006

(54) System and method for article detection

(76) Inventors: Robin G. Thurgood, Marshall, MI (US); Gerald Ulbrich, Battle Creek, MI (US); Michael A. George, Homer, MI (US); Robert F. Warner, Homer, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/033,337

(22) Filed: Jan. 11, 2005

(51) Int. Cl. G06K 9/34

(52) U.S. Cl. 382/176; 382/180

(57) ABSTRACT

A system and device are provided for detecting an article comprising a detecting portion adapted to receive a gate signal and generate values from optical characteristics of the gate signal, a trend determining portion adapted to identify a trend in the values, and an article passage identifying portion adapted to identify a passage of at least one article passing through at least a portion of the gate signal based on at least one change in trend of the trend determining portion.

### COPYRIGHT NOTICE

A portion of the disclosure of this patent document contains material which is subject to copyright protection. The copyright owner has no objection to the facsimile production by anyone of the patent document or patent disclosure as it appears in the U.S. Patent and Trademark Office patent file or records, but otherwise reserves all copyright laws whatsoever.

### TECHNICAL FIELD

The present invention generally relates to a system and method for detecting articles, and more specifically, the present invention relates to a system and method for detecting a passage of an article.

### BACKGROUND

In an increasingly automated society, article detection has generally been introduced and is commonly integrated in many applications. Systems and devices are generally offered that count articles by applying a light source or the like on the article to collect and record the light reflected therefrom.

Often times, however, the prior art attempts are ineffective at detecting and adjusting to various types of articles or differently situated articles. Such attempts generally require an operator to re-adjust or calibrate the devices as new articles are introduced to the system or the like.

### SUMMARY

To address these and other problems associated with conventional article detection devices, the present invention provides an article passage detector comprising a detecting portion adapted to receive a gate signal and generate values from optical characteristics of the gate signal, a trend determining portion adapted to identify a trend in the values, and an article passage identifying portion adapted to identify a passage of at least one article passing through at least a portion of the gate signal based on at least one change in trend of the trend determining portion.

### BRIEF DESCRIPTION OF THE DRAWINGS

The accompanying drawings illustrate various embodiments of the present system and method and are a part of the specification. The illustrated embodiments are merely examples of the present apparatus and method and do not limit the scope of the disclosure.

FIG. 1 is a schematic view of an article passage detector according to an embodiment of the present invention;

FIG. 1A is a schematic view of another article passage detector according to an embodiment of the present invention;

FIG. 1B is a schematic view of yet another article passage detector according to an embodiment of the present invention;

FIG. 2 is a perspective view of an article passage detector employed in an article transfer system according to an embodiment of the present invention;

FIG. 3 illustrates a grouping of cups as they intercept a signal gate and provides points that correlate to values extracted therefrom according to an embodiment of the present invention;

FIG. 3A is a signal representation of the cups as illustrated in FIG. 3 according to an embodiment of the present invention;

FIG. 4 is a method for detecting an article according to an embodiment of the present invention;

FIG. 4A is another method for detecting an article according to an embodiment of the present invention; and

FIG. 4B is another method for detecting an article according to an embodiment of the present invention.

### DETAILED DESCRIPTION

The present invention provides a system and method for detecting articles. In one aspect, the system and method may be used as a counter on a conveyor system. In such a system, the article passage detector may be used with a gate arranged in conjunction with a conveyor, wherein the conveyor transfers articles along a designated path and automated counting of the articles is desired. The article detection circuit herein described is adapted to recognize a trend of detected values of an input signal that is generated by the gate signal as an article passes through at least a portion of the gate signal. However, it should be noted that for purposes of the embodiments disclosed herein, instead of counting articles along a conveyor, the article detection circuit may be used to detect any article represented by the input signal. For clarity, however, an example related to detecting cups passing along a conveyor system is used in connection with the embodiments described below. Such a description is not intended to limit the embodiments to only cup detection and instead may be used with any item to be counted. The input signal may be derived from any blockage of the gate signal, such as partial blockage or full blockage. Such blockage results in a reduction or other change of the received input signal as discussed further herein.

The article passage detector receives information that relates to an article crossing through a gate signal connected to the circuit. Based on this information, the article passage detector is able to identify the passage of the article to thereby count the article. For illustrative purposes, a trend in voltage level is analyzed as the article passes to obtain this information. However, other types of information may similarly be analyzed, such as, for example, current levels, resistance levels and the like.

In an embodiment, the article passage detector uses threshold values to determine whether an article is present, and whether at least a second article follows. In an embodiment, the threshold value is derived from the information received at the article detection circuit and may represent a defining characteristic of a new article. In an embodiment, the threshold value is derived from a peak voltage level and in another embodiment the threshold value relates to a calculated variance between the peak value level and an existing value. For example, a first cup may be quickly followed by a second cup. In such a situation, the threshold value helps to prevent a false counting for reasons that will be discussed. For example, the second cup may at least partly overlap the first cup or be intertwined therewith. By setting a threshold value, each of the two cups are counted. These values may be established in a number of ways, including presetting the values in the system, various methods are also disclosed to dynamically adjust the values according to the corresponding signal that is generated from the interruption of the gate signal by the article, and the like. To determine whether an article is present or identified the article detection circuit references these values.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

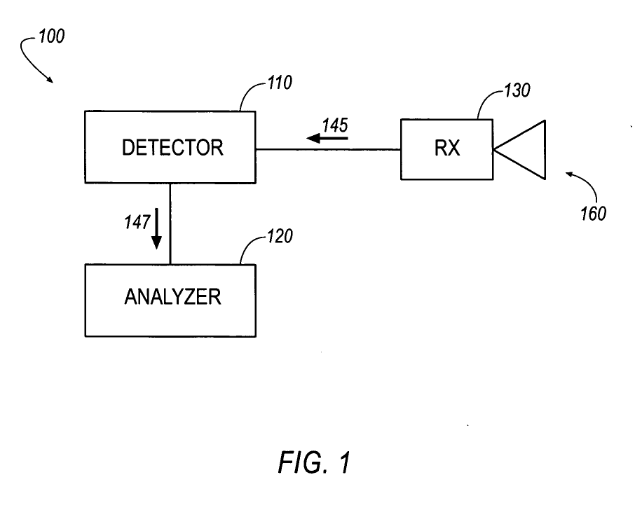

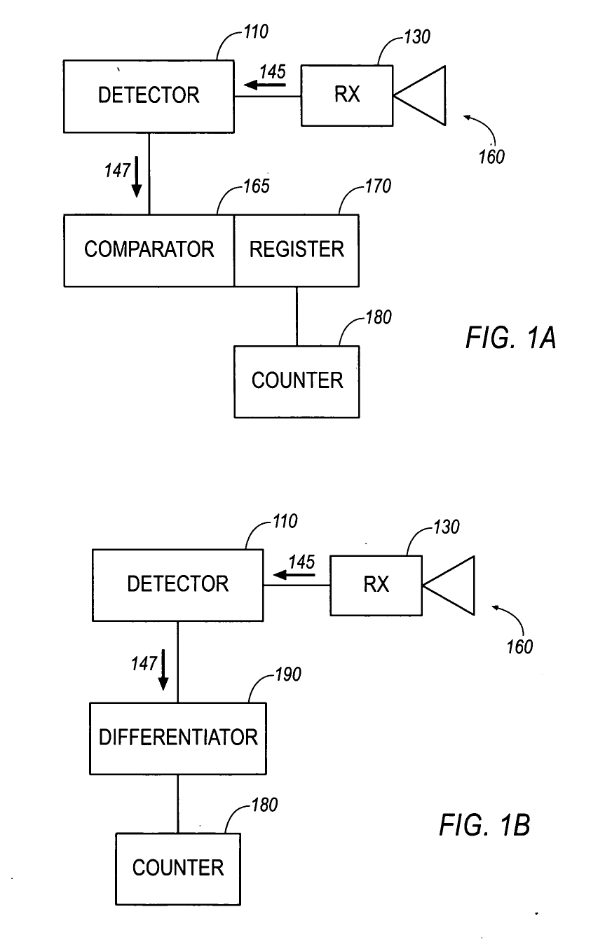

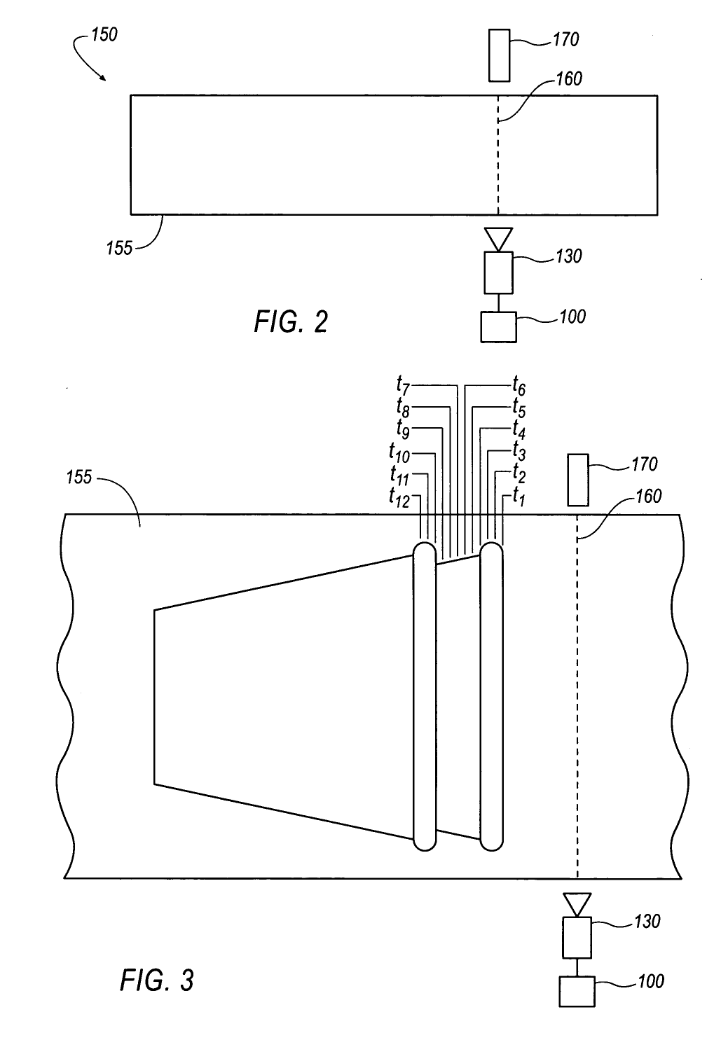

FIG. 1 is a schematic view of an article passage detector (100) that includes a detector (110) and an analyzer (120) connected to a gate receiver (130). The gate receiver (130) is adapted to collect input illumination, which varies based on interference with a gate signal (shown and described with respect to FIG. 2). The gate receiver (130) is additionally configured to output a information (145) that corresponds to an input characteristic that will further be discussed below. The detector (110) is adapted to receive the information (145) from the gate receiver (130).

FIG. 2 is a perspective view of an article transfer system (150) employing the article passage detector (100). In one example, the article transfer system (150) includes a conveyor system (155) and a transmitter (170) and then transmits a gate signal (160) across the path of the conveyor system (155) where articles are transferred. In the illustrated embodiment, the gate signal (160) is a signal generated by the transmitter (170) and received by the gate receiver (130). The gate signal (160) is arranged to pass across the conveyor system (155) at a location where select portions of the articles pass, the purposes of which will be herein described and well recognized when combined with the present disclosure.

The gate signal (160) may be a light gate, an infrared gate, sonic gate or the like. One of ordinary skill in the art will recognize that other alternatives similar to the depicted gate signal (160) herein described are equally foreseeable and may be used. Similarly, the receiver (130) may comprise a charge coupled device (CCD) that receives at least a portion of the gate signal (160) to send the receiver information (145) to detector (110). In such an example, the CCD includes an array of photosites located therein to collect a information (145) and output a information (145), which may be a signal or a charge, in response to reception of the gate signal (160). In another embodiment, each photosite outputs a voltage value that varies with intensity of received light. In yet another embodiment, each photocell provides a specific output based on either the presence or absence of light incident thereon. It should be noted that although a CCD is presently disclosed, other receivers may similarly be employed, such as, for example, a photodiode, a complementary metal oxide semiconductor (CMOS) or the like.

The receiver (130) receives and outputs information (145) relating to an optical characteristic of the signal (160). The optical characteristic is information relating to how much of the signal is blocked by the article passing thereacross. For example, where the signal (160) is light, whether visible or other frequencies, the optical characteristic may be intensity, luminance, based on number of photosites blocked by the article or any other measurable feature representing blockage of the signal (160).

The detector (110) receives the information (145) from the detector (110). The detector (110) analyzes the information (145) to assign a value to the information based on its strength. For example, in the embodiment described above, where each photosite outputs a value based on illumination incident thereon, the detector (110) assigns a cumulative value to the outputs from each photo site. The detector (110) then outputs a signal (147) representing that value, which may be analog or digital, to the analyzer (120). In another example, the receiver (130) assigns the cumulative value to the outputs from each photosite. In even another example, the inputs of the photosites are communicated in an array, or transferred in a matrix format, to the detector and analyzed in that form. It should also be noted that the detector (110) and receiver (130) can be one component, such as where the receiver (130) directly outputs a signal representative of the optical characteristic that can be used to identify a trend in the optical characteristic.

The analyzer (120) is a device that receives the signal from the detector (110) to analyze and identify increasing and decreasing trends in signals (147) received from the detector (110) as will be discussed in further detail below.

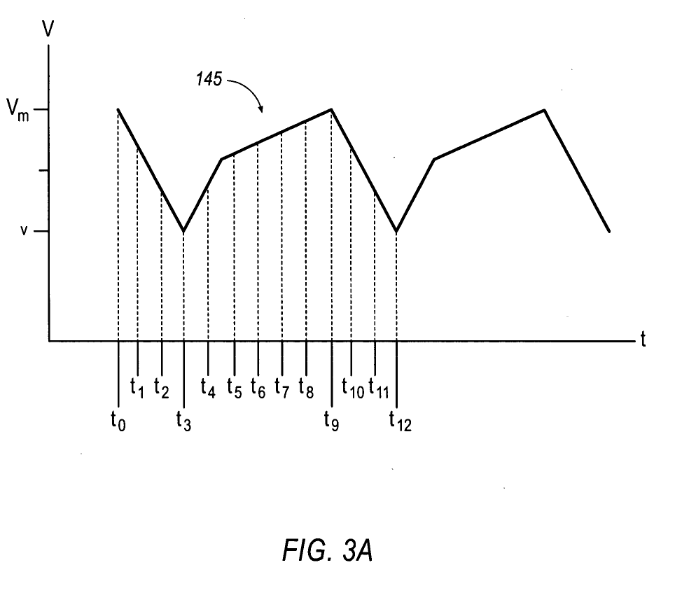

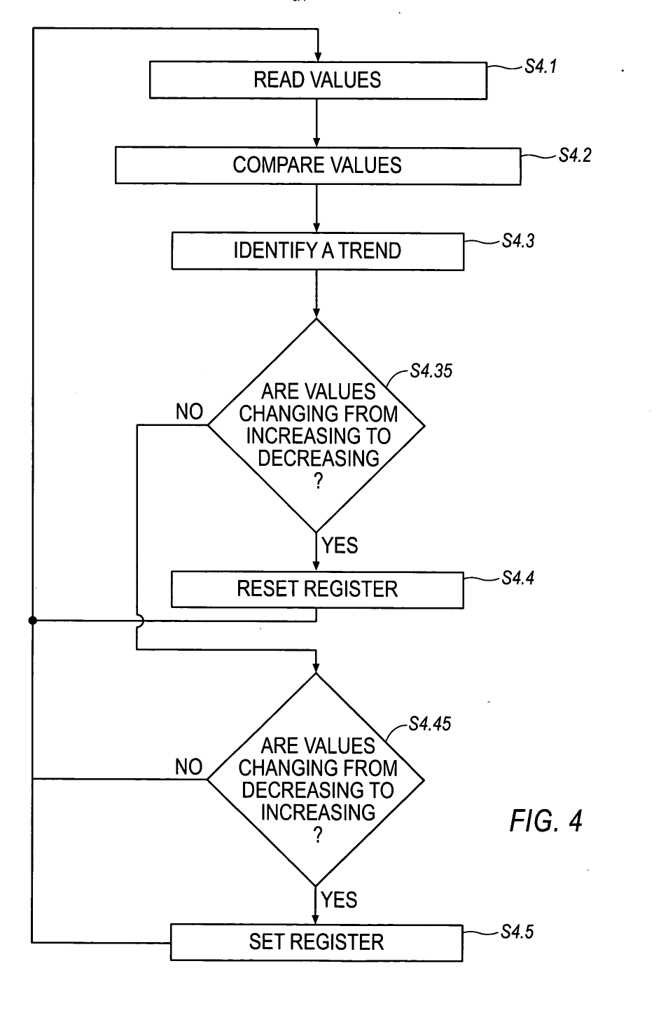

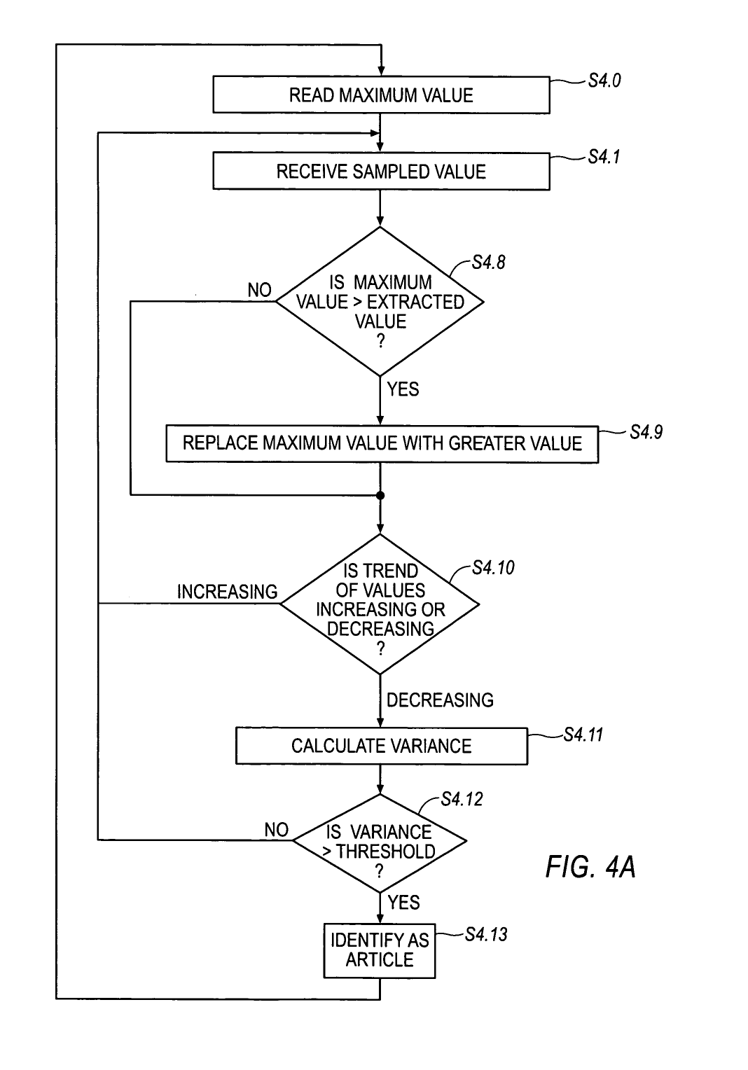

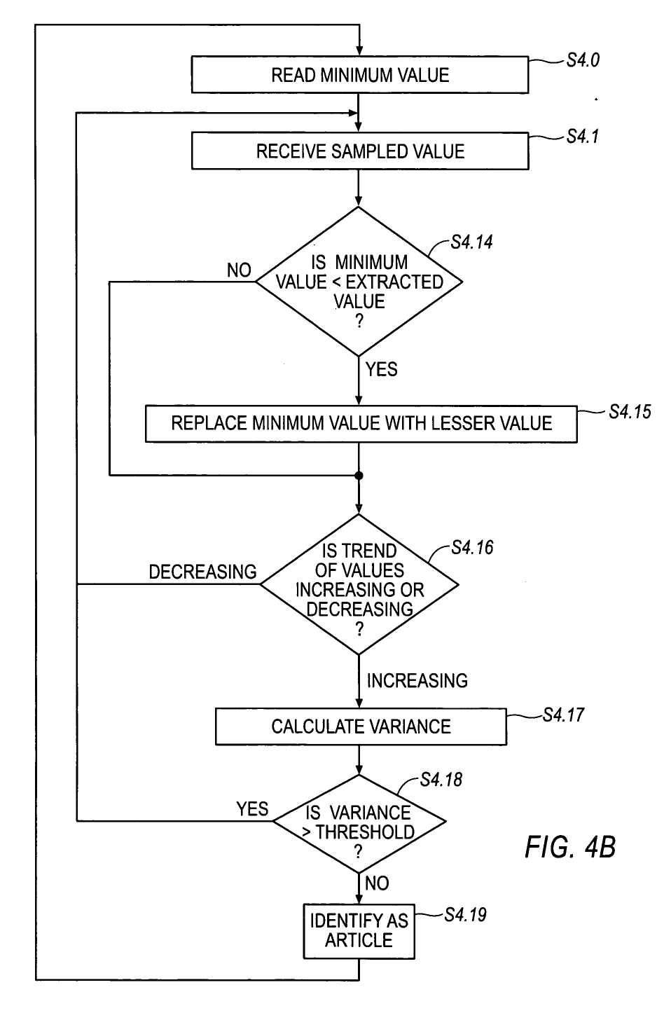

Referring now to FIGS. 3 and 4, the articles carried by conveyor system (155) are shown, by way of example, as cups. The cups are shown in FIG. 3 as being organized into a grouping of cups that intercept the gate signal (160). The figure generally provides an example of points that correlate to at least two output values (v₁, v₂ . . . vₓ) derived from the signal (147). The output values are optical characteristics, such as intensity, received by the gate receiver (130) as corresponding points along the cup (t₁, t₂, tₓ) pass across the gate signal (160). Because of the characteristics of the cups, such as for example, whether the cup is opaque and the geometry of the cup, different optical characteristics will be received at the gate receiver (130) at different points tₓ along the cup. Accordingly, as the cups intercept the gate signal (160), a graphical representation of the signal (147) may be generated based on these varying values at respective points tₓ, such as the one illustrated in FIG. 3A. In one example, the value v represents a voltage of the signal (147). However, one skilled in the art will readily recognize that other values associated with the signal (147) may be used as well.

The optical characteristic may be luminescence, intensity or any other value correlated to the amount of, or intensity of light associated with blockage of the gate signal (160) by a particular cup. In one example, an increased blockage of the gate signal (160) is associated with a reduced voltage output from the receiver (130). Accordingly, the signal (147) represents the variance in this reduced voltage from the receiver (130).

The time values tₓ shown on the signal in FIG. 3A correspond to the values tₓ illustrated on the cups in FIG. 3. It should be noted that although cups are illustrated and disclosed, a similar signal may be generated for any type of article passing through the gate. Moreover, although the signal corresponds to a voltage level, the signal may correspond to other identifiable values, such as, for example, current, resistance and the like.

In the illustrated embodiment, between t₁ and t₄, the slope of the signal (147) shown at FIG. 3A is greatest as the lip of the cup intercepts the gate signal (160). This result is a function of the large reduction in light incident on the receiver (130) as the lip of the cup passes through the gate signal (160). Then, the signal (147) gradually changes from t₅ through t₉ as the body of the cup is transferred through the gate signal (160). This phenomenon is repeated at t₁₀ as a different cup passes through the gate signal (160) and continues as more cups pass. A signal (147), such as the one shown in FIG. 3A, may be generated for any article passing through the gate signal (160). It will also be noted that, although the signal itself may change, the direction of the trend, such as increasing or decreasing, stays the same even if the cups are spread lengthwise apart or if they are positioned vertically (with respect to the figure) relative to the gate signal (160). Thus, if the cups are vibrating on a conveyor or otherwise passing through different portions of the gate signal (160), using the trend to identify passage of the article helps ensure accurate counting or identification of passage (which will be discussed further). The variance, as explained below, also assists accurate counting during such a situation.

As can be seen from the above description, cups have a specific trend pattern. The trend pattern includes one trend change from increasing to decreasing. The trend pattern may also include changes in trend, such as from gradually increasing to rapidly increasing. One skilled in the art will readily recognize that other articles may have a different trend pattern, such as for each article, the trend may increase and then decrease and then increase again. The trend pattern may decrease followed by an increase. The trend pattern may also include any combination or multiple combinations thereof.

By counting characteristics of this trend pattern, such as with the cup example, counting each trend change, one can count cups or other articles passing through the gate signal (160). Therefore, the system can recognize one article by counting some feature of such a trend pattern.

In an embodiment, the detector (110) is adapted to sample at least two values (v₁, v₂ . . . vₓ) at two points along the article. The values (v₁, v₂ . . . vₓ) are sampled at particular time moments (tₓ) along the signal (147). Of course, instead of time moments, the values may be sampled at distance locations or at any other incremental means. The rate of sampling may vary. In an embodiment, the signal (147) is sampled at or about one millisecond intervals. However, it should be noted that the sampling rate may be adjusted based on the article detected. For illustrative purposes, (v₁, v₂ . . . vₓ) are extracted from the signal (147) as shown in FIG. 3A.

Referring now to FIG. 1A, in an embodiment, the analyzer includes a comparator (165) that compares the values (v₁, v₂ . . . vₓ) and, in connection with a register (170), determine a trend of the values. It should be noted that as the number of sampled values (v₁, v₂ . . . vₓ) increase, the sensitivity and the accuracy of the circuit will also generally increase.

With continued reference to FIG. 1A, the register (170) is further described. The comparator (120) analyzes the sampled values (v₁, v₂ . . . vₓ) and the register (170) indicates when the trend of the sampled values (v₁, v₂ . . . vₓ) is increasing or decreasing. For illustrative purposes, the register may be binary. That is, when the sampled values (v₁, v₂ . . . vₓ) change from decreasing to increasing, the register sets (i.e. read ‘1’), and when the sampled values (v₁, v₂ . . . vₓ) change from increasing to decreasing, the register resets (i.e. read ‘0’), or vice versa. One skilled in the art will readily recognize alternatives to the register embodiment described herein.

As illustrated FIG. 1A illustrates a counter (180) that is connected to the register (170). In an embodiment, the counter (180) is adapted to count the article as the article passes through the gate signal (160) and is identified. The counter performs this function by reading a specific number of times the trend changes from increasing to decreasing or decreasing to increasing. As described earlier, an article being counted has a specific trend associated therewith. For example, with respect to the cup illustration provided in FIG. 3A and the associated graph in FIG. 3B, each cup is associated with a decrease in trend and an increase in trend. Therefore, for each decrease and increase in trend, represented by a set and reset of the register, the counter (180) records one count.

In even another embodiment, successive values (v₁, v₂ . . . vₓ) are sampled from the signal (147) to identify a trend. In this embodiment, the comparator (120) reads the value v₁ from the detector (110) for a point t₁. The comparator (120) then reads v₂ for the next point t₂. If v₂ is larger than v₁, then the comparator (190) stores v₂ as a maximum value (vₘₐₓ). The comparator (190) continues this process until the next v is less than the previous v for the sampled values (v₁, v₂ . . . vₓ). Once a next v is less than vₘₐₓ, a decrease in trend is revealed. As such, the counter (190) is able to record the change in trend or the comparator itself is able to record the change in trend. The above described process can also be used with respect to a decreasing trend where the vₘᵢₙ is stored for each successive v.

It should be noted, however, that other changes in trends may also be measured through the use of the above identified embodiments. Specifically, the present invention analyzes changes in trend characteristics when those characteristics are known. For example, if an article as a characteristic trend that transitions from a gradual increase to a rapid increase, that trend can be counted to count or identify the passage of the article. One skilled in the art will readily recognize other changes in trend, such as from rapidly decreasing to gradually decreasing, gradually decreasing to rapidly increasing, or as discussed above, changes from positive slope to negative slope or negative slope to positive slope.

In the above described embodiment, a variance (x) may be used to reduce possible error from noise, abnormal variations in article geometry or any other unanticipated problems. More specifically, noise may cause a next v to be less than vₘₐₓ when the actual trend has not changed from increasing to decreasing, or vice versa. With respect to the above identified example for an increasing trend, the variance (x) represents some minimum number of successive number of decreasing values of v or a percentage or amount decrease in the actual value of v that must be obtained before the differentiator will indicate a change in trend and therefore before the counter (190) will record such a change in trend.

The variance may be adjusted according to the article to be detected. Such adjustments may be statically provided or dynamically determined by the system. For example, with regard to the cup detection system, the variance is set at or between four and fifteen percent below the maximum value (vₘₐₓ). The counter (180) increments when the value of v passes the variance (x). Although a maximum value vₘₐₓ is described in the previous embodiments, the system may instead detect the article by identifying a minimum value, vₘᵢₙ. Likewise, in the embodiments described above, the variance (x) is measured when the system (100) determines that the trend of the sampled values (v₁, v₂ . . . vₓ) is increasing after they substantially reach vₘᵢₙ.

A method according to an embodiment comprises first determining a trend in values associated with an optical characteristic of light received from a light gate. An article is counted based on at least one change in the trend from either increasing or decreasing or decreasing to increasing. Likewise, depending on the trend signature, such as if an increase and a decrease represent that one article has passed through the light gate, the article may be counted after a predefined number and type of trend changes occur. For example, where an article is associated with a trend increase and a trend decrease, once both of those events happen, one of such an article type would be counted.

FIG. 1B illustrates a schematic view of another article detection circuit (100) according to an embodiment of the present invention. In the embodiment, the analyzer (120) includes a differentiator (190) that calculates a running average (Δvₐᵥₑ/Δt) of the rate of change per unit time of the values (v₁, v₂ . . . vₓ). The differentiator (190) measures characteristics of this average (Δvₐᵥₑ/Δt) to identify a trend of the values (v₁, v₂ . . . vₓ).

One characteristic that identifies a trend is the instantaneous rate of change (Δv/Δt) or fluctuation, when compared to the average rate of change (Δvₐᵥₑ/Δt). In one example, the differentiator (190) calculates the slope of the signal (147) or v between tₓ and tₓ₊₁. Once this rate is determined, the differentiator (190) compares this calculated rate to the average rate to find the difference therebetween. By this way, the change in trend is based on the instantaneous change in v with respect to a time average change in v. Depending on this difference, the differentiator (190) determines whether the trend of the values indicates that an article has passed. If the calculated difference exceeds a threshold difference for the change in trend, the differentiator outputs a signal to indicate the presence of an article. It should be noted that this threshold difference may be statically set (manually provided), or dynamically determined by or within the system.

One way that this threshold difference may be dynamically determined is a function of the Δvₐᵥₑ. Specifically, (Δvₐᵥₑ±YΔvₐᵥₑ)/Δt may be used as the threshold value, where Y may be any value between 0 and 1. For example, Y may be set at or between 5 and 15 percent. Other methods to set the threshold will be recognizable by one of ordinary skill in the art when combined with the present disclosure.

In a similar manner, the disclosed embodiments provide various methods and configurations to determine the trend of the values (v₁, v₂ . . . vₓ) and identify an article according to the determined trend. Other methods and configurations to determine such a trend of the values will become foreseeable when combined with the present disclosure. It should be noted that these methods and configurations do not vary from the scope of the present invention beyond what one of ordinary skill in the art will readily recognize.

With reference now to FIG. 4, another method for detecting an article is illustrated and described. In the method shown in FIG. 4, at least two values (v₁, v₂ . . . vₓ) are read from the signal (147) in step S4.1. The at least two values (v₁, v₂ . . . vₓ) are then compared in step S4.2, and a trend is identified from the at least two values (v₁, v₂ . . . vₓ) in step S4.3. The values are analyzed to determine whether they are changing from increasing to decreasing, and/or vice versa in step S4.35 and S4.45 respectively.

With continued reference to FIG. 4, the register depicted in FIG. 1A is reset in step S4.4 when the at least two values change from increasing to decreasing and set in step S4.5 when the at least two moment values change from decreasing to increasing. This setting and resetting may occur after the variance (x) is passed after a trend change. Finally, a counter, such as counter 180 in FIG. 1A, connected to the register may be incremented when one of the following occurs. The register is set, the register is reset, both, or some combination based on the trend signature of the article being counted.

An alternate method for detecting an article according to an embodiment of the present invention is illustrated in FIG. 4A. Here, the comparator first reads a maximum value (vₘₐₓ) provided from a previous iteration of the system in step S4.0. Then a value is provided from the detector in step S4.1. The comparator compares the value to the maximum value (vₘₐₓ) in step S4.8. If the value is greater than the maximum value (vₘₐₓ), the comparator replaces the maximum value (vₘₐₓ) with the greater value in step S4.9. The comparator next determines whether the trend of the values provides that the values are increasing or decreasing in step S4.10 according to methods described above. If the trend of the values is that they are increasing, the system returns to step S4.1. If the trend of the moment values provides that the values are decreasing and that the article has not yet been identified, the system measures the variance (x) between the maximum value (vₘₐₓ) and the value (v₁, v₂ . . . vₓ) in step S4.11. Next, the comparator compares the variance to the predefined threshold in step S4.12. If the variance is at or about the pre-defined threshold, the comparator provides that an article is identified in step S4.13.

In another embodiment provided in FIG. 4B, the comparator first reads a minimum value (vₘᵢₙ) provided from a previous iteration of the system in step S4.0. Then a value is read from the signal in step S4.1. The comparator compares the value to the minimum value (vₘᵢₙ) in step S4.14. If the value is less than the minimum value (vₘᵢₙ), the comparator replaces the minimum value (vₘᵢₙ) with the lesser value in step S4.15. The comparator next determines whether the trend of the values provides that the values are increasing or decreasing in step S4.16 according to methods described above. If the trend of the moment values is that they are decreasing, the system returns to step S4.1. If the trend of the moment values provides that the values are increasing and that the article has not yet been identified, the system measures the variance (x) between the minimum value (vₘᵢₙ) and the value (v₁, v₂ . . . vₓ) in step S4.17. Next, the comparator compares the variance to the predefined threshold in step S4.18. If the variance is at or about the pre-defined threshold, the comparator provides that an article is identified in step S4.19.

While the foregoing has described what are considered to be preferred embodiments of the present invention, it is understood that various modifications may be made therein and that the invention may be implemented in various forms and embodiments, and that it may be applied in numerous applications, only some of which have been described herein. It is intended by the following claims to claim all such modifications and variations, which fall within the true scope of the invention.

What is claimed is:

1. An article passage detector comprising:
a detecting portion adapted to receive a gate signal and generate values from optical characteristics of the gate signal;
a trend determining portion adapted to identify a trend in the values; and
an article passage identifying portion adapted to identify a passage of at least one article passing through at least a portion of the gate signal based on at least one change in trend of the values.

2. The article passage detector according to claim 1, wherein the article passage identifying portion is adapted to count the article passing through the gate signal based on the at least one change in said trend.

3. The article passage detector according to claim 2, wherein the identifying portion is adapted to count the article after a variance from a peak value of said trend occurs.

4. The article passage detector according to claim 2, wherein the article identifying portion is adapted to count a plurality of articles passing through at least a portion of the gate signal.

5. The article passage detector according to claim 4, wherein at least a portion of the articles passes through a different portion of the gate signal than a remaining portion of the articles.

6. The article passage detector according to claim 1, wherein:
the detecting portion includes a detector and a receiver;
the gate signal is incident on the receiver;
the receiver is adapted to output information representative of the optical characteristic of the gate signal; and
the detector is adapted to generate a value representative of the optical characteristic.

7. The article passage detector according to claim 1, wherein said trend determining portion is a comparator that is adapted to define said trend and indicate when said values are increasing and decreasing.

8. The article passage detector according to claim 7, further comprising:
a register;
wherein said register is adapted to set when said trend changes from decreasing to increasing and reset when said trend changes from increasing to decreasing.

9. The article passage detector according to claim 8, further comprising a counter adapted to increment when said register is selected from the group consisting of set, reset, set and reset, or a predetermined number of sets and resets.

10. The article passage detector according to claim 1, wherein:
said trend determining portion is a comparator;
said article passage identifying portion is a counter;
said comparator is adapted to determine and store a maximum or minimum value for each consecutive increasing or decreasing one of the values respectively; and
said comparator is adapted to output a signal to the counter after a next of the consecutive one of the values is no longer increasing or decreasing.

11. The article passage detector according to claim 1, wherein:
said trend determining portion is a comparator;
said article passage identifying portion is a counter;
said comparator is adapted to determine and store a maximum or minimum value for each consecutive increasing or decreasing one of the values respectively;
said comparator is adapted to output a signal to the counter when a next of the values is no longer increasing or decreasing with respect to the respective maximum or minimum value after a variance from the respective maximum or minimum value occurs.

12. The article passage detector according to claim 11, wherein the variance is a number of values after the respective maximum or minimum value having a different trend than values before the respective maximum or minimum value.

13. The article passage detector according to claim 5, further comprising:
a conveyor adapted to transfer at least one article across said gate signal;
wherein said gate signal is arranged with said conveyor to intersect at least a portion of said article.

14. The article passage detector according to claim 1, wherein:
said trend determining portion is a differentiator
said article passage identifying portion is a counter;
said differentiator is adapted to determine an average rate of change of said values and an instantaneous rate of change of said values and compare each of said instantaneous rate of change and said average rate of change to determine the trend of said values; and
said differentiator is adapted to output a signal to the counter when a difference between said average rate of change and said instantaneous rate of change exceeds a threshold difference.

15. The article passage detector according to claim 14, wherein said threshold difference is the average rate of change plus or minus a percentage thereof.

16. A method for detecting an article comprising the steps of:
providing a gate signal having optical characteristics;
providing a detecting portion for receiving said gate signal;
generating values from optical characteristics of the gate signal;
identifying a trend in the values; and
identifying a passage of at least one article passing through at least a portion of the gate signal based on at least one change in trend of the values.

17. The method according to claim 16, further comprising the step of:
counting the article passing through the gate signal based on the at least one change in said trend.

18. The method according to claim 16, further comprising the step of:
counting the article after a variance from a peak value of said trend occurs.

19. The method according to claim 17, wherein at least a portion of the articles passes through a different portion of the gate signal than a remaining portion of the articles.

20. The method according to claim 16, wherein the detecting portion includes a detector and a receiver, and the gate signal is incident on the receiver, the method further comprising the steps of:
outputting information representative of the optical characteristic of the gate signal by said receiver; and
generating a value representative of the optical characteristic by said detector.

21. The method according to claim 16, wherein said trend is determined by a comparator, said method further comprising the steps of:
defining said trend in said comparator; and
indicating when said values are increasing and decreasing.

22. The method according to claim 21, further comprising the steps of:
providing a register connected to said comparator;
setting said register when said trend changes from decreasing to increasing; and
resetting when said trend changes from increasing to decreasing.

23. The method according to claim 22, further comprising the steps of:
providing a counter connected to said comparator; and
incrementing said counter when said register is selected from the group consisting of set, reset, set and reset, or a predetermined number of sets and resets.

24. The method according to claim 16, wherein said trend is determined by a comparator, said method further comprising the steps of:
providing a counter;
determining a maximum or minimum value for each consecutive increasing or decreasing one of the values respectively by said comparator;
storing said maximum or minimum value by said comparator; and
outputting a signal from said comparator to the counter after a next of the consecutive one of the values is no longer increasing or decreasing.

25. The method according to claim 24, wherein said outputting step outputs the signal after a variance from the respective maximum or minimum value occurs, wherein said variance is a number of values after the respective maximum or minimum value having a different trend than values before the respective maximum or minimum value.

26. The method according to claim 25, wherein the variance is an amount which at least one value after the respective maximum or minimum value varies from the maximum or minimum value when the value after has a different trend than values before the respective maximum or minimum value.

27. The method according to claim 16, further comprising the steps of:
providing a conveyor;
arranging said gate signal on said conveyor.

28. The method according to claim 16, wherein said trend determining portion is a differentiator, and said article passage identifying portion is a counter, said method further comprising the steps of:
determining an average rate of change of said values by said differentiator;
determining an instantaneous rate of change of said values by said differentiator;
comparing each of said instantaneous rate of change and said average rate of change by said differentiator;
determining the trend of said values by measuring the difference between said instantaneous rate of change and said average rate of change; and
outputting a signal from the differentiator to the counter when said differentiator difference between said average rate of change and said instantaneous rate of change exceeds a threshold difference.

29. The article passage detector according to claim 28, wherein said threshold difference is the average rate of change plus or minus a percentage thereof.
